(19) United States
(12) Patent Application Publication
(10) Pub. No.: US 2026/0187966 A1
(43) Pub. Date: Jul. 2, 2026

(54) LANGUAGE-DRIVEN SEGMENTATION FOUNDATION MODEL FOR GENERAL MEDICAL IMAGE ANALYSIS

(71) Applicant: The Hong Kong University of Science and Technology, Hong Kong (CN)

(72) Inventors: Xiaomeng LI, Hong Kong (CN); Haonan WANG, Hong Kong (CN)

(21) Appl. No.: 19/435,798

(22) Filed: Dec. 30, 2025

Related U.S. Application Data
(60) Provisional application No. 63/740,327, filed on Dec. 31, 2024.

(51) Int. Cl. G06V 10/26; G06F 40/284; G06F 40/40; G06T 7/00; G06T 7/11; G06V 10/25; G06V 10/40; G06V 10/764; G06V 10/77; G06V 20/50

(52) U.S. Cl. CPC G06V 10/267; G06F 40/284; G06F 40/40; G06T 7/0012; G06T 7/11; G06V 10/25; G06V 10/40; G06V 10/764; G06V 10/77; G06V 20/50; G06T 2207/10056; G06T 2207/10068; G06T 2207/10081; G06T 2207/10088; G06T 2207/10104; G06T 2207/10116; G06T 2207/10132; G06T 2207/30041; G06T 2207/30088; G06V 2201/03

(57) ABSTRACT

The present invention provides a full-stack medical imaging foundation model, re for performing medical image segmentation, classification and localization using a unified language-image correlation mechanism. The present invention leverages pretrained language-guided associations to automatically recognize and localize disease targets without requiring medical imaging knowledge or manual box-prompting. The invention enables comprehensive clinical tasks across multiple disease classes and various medical imaging techniques, improves segmentation efficiency, and reduces human input burden. With operability through human language-only prompts by non-radiology specialists, the present invention improves real-world applicability and enables deployment of foundation model-based segmentation in diverse clinical environments.

### CROSS-REFERENCES TO RELATED DOCUMENTS

The present application claim priority to U.S. Utility Patent application no. 63/740,327 filed Dec. 31, 2024; the disclosure of which is incorporated herein by reference in its entirety.

### FIELD OF THE INVENTION

The present invention relates to automated medical image segmentation and analysis. More specifically, the present invention provides a language-driven medical image segmentation model and device.

### BACKGROUND OF THE INVENTION

Medical image segmentation is a fundamental task in medical image analysis, involving the identification and delineation of anatomical structures, organs, lesions, and pathological regions within medical images such as magnetic resonance imaging (MRI), computed tomography (CT), ultrasound, fundus imaging, and other radiological modalities. This is crucial in numerous clinical workflows, including lesion measurement, organ volumetry, surgical planning, radiotherapy contouring, and disease quantification. Accurate segmentation holds significant clinical value as it directly affects diagnostic accuracy, treatment planning precision, and surgical navigation.

Traditionally, segmentation has been performed manually by trained radiologists or imaging specialists, typically by outlining regions of interest on medical scans on a slice-by-slice basis. Manual annotation, however, is time-consuming, subjective, and labor-intensive, and is prone to human error. Automated segmentation algorithms have therefore been developed to reduce manual labor and improve consistency.

Additionally, lead-based solders are also problematic from an environmental and regulatory standpoint. Regulations such as the European Union's RoHS (Restriction of Hazardous Substances) directive restrict the use of lead due to its toxicity, pushing the electronics industry to adopt lead-free alternatives.

Recent advances in deep learning, including fully convolutional neural networks, transformer-based architectures, and foundation-style vision models pretrained on large-scale medical imaging datasets, have significantly improved automated segmentation accuracy. These newer models rely on region-of-interest guidance such as bounding boxes, scribbles, pixel hints, or initial coarse contours provided by specialists. Even with current state-of-the-art interactive segmentation systems, trained radiologists are often still required to visually identify the suspected region and draw bounding boxes or other localization cues so that the model can focus its inference on the targeted target structure.

As such, these systems remain dependent on expert interaction during inference, require specialized knowledge in the art to provide valid localization cues, and are not readily accessible to non-radiologist users, as they do not fully integrate segmentation masks with prompts other than visual cues and guidance provided by experts. Therefore, non-radiologists still have extremely limited accessibility to using these systems.

Accordingly, there remains a need for an automated medical image segmentation system that is operable by non-radiology specialist users, particular through prompts that are not limited to visual cues and guidance.

In response to the need to improve accuracy in medical image segmentation and minimize human errors, various AI-incorporated models have been developed, one of the more recent developments being the Segment Anything Model (SAM), which allows users to segment any region of interest using point or box prompts.

MedSAM is subsequently proposed as a medical variant of SAM, designed specifically for medical images and requiring interactive prompts such as points and bounding boxes. However, these interactive methods require human intervention in real-world medical image analysis scenarios; detection is time-consuming, and diagnosis requires expertise. Additionally, offering point prompts demands expertise in medical imaging, and using box prompts is even more complicate, making these approaches less practical.

A possible solution is provided by integrating language guidance to develop a vision-language segmentation foundation model. Representative tools in general machine learning communities such as CLIP, LLaVa, and GLaMM, among others, use large-scale image-caption pairs to pre-train Visual-Language Foundation Models (VLFMs) that demonstrate robust performance in downstream vision tasks. In the broader biomedical imaging domain, various VLFMs are proposed to enhance understanding across different applications, such as pathology images and echocardiograms, among others.

However, there has not been sufficient investigation in integrating language guidance for segmentation. A more recent attempt demonstrates the potential of using triplet image-mask-label data to learn meaningful visual representations and develops foundation models for segmentation that are transferred to multiple segmentation tasks across various modalities in a zero-shot setting. Biomedparse, a more successful model, is trained on a large-scale dataset comprised of 3.4 million image-mask-label triplets and demonstrates comparable performance with MedSAM.

However, Biomedparse faces several significant limitations. Firstly, strong correlations between images and language instructions are not established, primarily because simple labels are relied upon, specifically class names. The issue arises from a gap between the simple semantic information conveyed by the class name and the complex morphological information represented by the masks, class names often fail to provide details about the location and shape of anatomical structures, which are crucial for a comprehensive understanding of their morphology.

Additionally, because of the limited training data, Biomedparse overfits specific distributions, leading to unsatisfactory performance in real-world application scenarios, such as unseen data and classes, and clinical evaluation. These crucial characteristics of foundation models remain underexplored. Therefore, there is a pressing need to develop a practical foundation model with robust image-language correlation across various biomedical objects in real-world hospitals.

### SUMMARY OF THE INVENTION

To address the unmet needs in the current state of the art as stated above, one aspect of the present invention provides an automated medical image segmentation device configured for segmentation, classification and localization of regions of interest from multiple medical image types by human language-only prompts. The automated medical image segmentation device comprises a human language prompt input unit, an image display unit and a medical image segmentation processing unit configured to execute an intelligent segmentation model. Particularly, the intelligent segmentation model is pre-trained with image-mask-description triplets. As such, the processing time for medical image segmentation of the device is reduced by 99% compared to conventional medical image segmentation systems.

In one embodiment of the present invention, the intelligent segmentation model comprises an image encoder for encoding the target medical image into image features, a human language prompt encoder for tokenizing the human language instructions into tokenized instructions, a vision-to-language projection module for projecting the image features to a language space, a large language model (LLM) for integrating the projected image features and the tokenized instructions, a language-to-vision projection module for projecting output generated by the large language model to a vision space, and a mask decoder for producing binary segmentation masks to generate a medical image with segmentation results

In another embodiment, the intelligent segmentation model is pre-trained with datasets containing image-mask-description triplets. The datasets are constructed by a Color Region Description (CRD) strategy, which comprises (i) receiving 3D medical images and converting the 3D medical images into 2D slices; (ii) generating 2D masks from the 2D slices; (iii) inputting the 2D masks into a vision-language foundation model, (iv) converting image features contained in the 2D masks into pre-defined colored masks, (v) inputting the pre-defined colored masks into the vision-language foundation model to generate descriptions, and (vi) combining each of the 2D masks with the corresponding pre-defined colored masks and the descriptions generated to form image-mask-description triplets.

In another embodiment, the medical image types that can be processed by the device of the present invention are selected from computer tomography (CT) images, magnetic resonance images (MRI), positron emission tomography (PET) scan images, fundus photography images, X-ray images, pathology microscopy images, endoscopy images, ultrasound images and dermoscopy images.

In another embodiment, the intelligent segmentation model has an average improvement of 4% in Dice similarity coefficient (DSC) over conventional medical image segmentation models.

In yet another embodiment, the intelligent segmentation model has a classification accuracy of at least 30% higher than those of conventional multi-model large foundation models.

In yet another embodiment, the intelligent segmentation model has a Box Intersection over Union (IoU) at least 20% higher than those of conventional multi-model large foundation models.

In accordance with another aspect of the present invention, a method of automated segmentation, classification and localization of regions of interest from multiple medical image types by human language-only prompts using the automated medical image segmentation device is provided. The method comprises (i) receiving a medical image to be processed in the device, (ii) receiving human language instructions in the form of human language-only prompts by a human language prompt input unit of the device, (iii) encoding the medical image into features by a pre-trained image encoder executed by a medical image segmentation processing unit of the device, (iv) projecting the image features to language space by a vision-to-language projection module executed by the medical image segmentation processing unit, (v) integrating the projected image features and human language-only prompts by a LLM executed by the medical image segmentation processing unit, (vi) generating output by the LLM, (vii) projecting the output to a vision space by a language-to-vision projection module executed by the medical image segmentation processing unit, (viii) feeding the output in the vision space into a mask decoder executed by the medical image segmentation processing unit, (ix) producing binary segmentation masks by the mask decoder to generate a medical image with segmentation results, and (x) displaying the medical image with segmentation results by an image display unit of the device.

In one embodiment, the binary segmentation masks are produced by the process comprising: (i) inputting the tokenized instructions, (ii) generating responses with specialized tokens corresponding to specific tokens in the tokenized instructions regarding image segmentation categories, (iii) transforming last-layer embeddings into a feature space of the mask decoder corresponding to the specialized tokens by the vision-to-language projection module, and (iv) generating the binary segmentation masks by the mask decoder based on the feature space.

In another embodiment, the processing rate of the method is no less than 700 images per hour.

In another embodiment, the medical image types that are compatible with the method are selected from CT images, MRI, PET scan images, fundus photography images, X-ray images, pathology microscopy images, endoscopy images, ultrasound images and dermoscopy images.

In yet other embodiment, the method has an average improvement of 4% in DSC over conventional medical image segmentation models.

In yet another embodiment, the method has a classification accuracy of at least 30% higher than those of conventional multi-model large foundation models.

In yet another embodiment, the method has a Box IoU of at least 20% higher than those conventional multi-model large foundation models.

### BRIEF DESCRIPTION OF THE DRAWINGS

Embodiments of the invention are described in more details hereinafter with reference to the drawings, in which:

FIGS. 1A and 1B provide a schematic overview of the concept of the present invention; FIG. 1A provides an illustrative comparison of the full-stack intelligent segmentation model of the present invention with previous models across three key clinical stages of medical image analysis; FIG. 1B provides an example as to the superior vision-language correlation of the present invention over existing text-driven segmentation foundation model;

FIGS. 2A and 2B provide a comparison of the performance on held-out evaluation dataset with 835,000 images with different levels of medical imaging knowledge required; FIG. 2A shows a comparison plot of the average DSC against different levels of medical imaging knowledge required; FIG. 2B shows the comparison of categories with the top 30 DSCs of the present invention;

FIGS. 3A to 3D show the comparison of segmentation performance of the model of the present invention operated by users without training in medical imaging with junior/senior doctors using conventional medical image segmentation models requiring box prompts as visual cues; FIG. 3A compares the overall segmentation results across different external datasets through DSC; FIG. 3B compares the segmentation performance of each class on the public datasets and in-house datasets through DSC respectively; FIG. 3C provides a visual comparison of segmentation performances of different types of images (CT and ultrasound); FIG. 3D provides a visual comparison of segmentation performances across different types of tumors in different organs;

FIG. 4 tabulates the classification performances with interactive segmentation models (MedSAM and SAM-Med2D) and multi-model large foundation models (LLaVA-Med and MedRegA); ‘X’ denotes the corresponding function that is not supported;

FIG. 5 tabulates the localization performances with interactive segmentation models (MedSAM and SAM-Med2D) and multi-model large foundation models (MedRPG); ‘X’ denotes the corresponding function that is not supported;

FIGS. 6A and 6B provide a comparison of user studies of the present invention with radiologists using conventional medical image segmentation models; FIG. 6A provides an illustration highlighting the impracticality of the current technology due to its inability in localization and diagnosis from medical images, and its relatively low efficiency as reflected in the high time cost; LanMed shows the XRD spectrum of the copper metal particle, as compared to the intelligent segmentation model in accordance with the embodiments of the present invention (hereinafter referred to as “LanMedia”) used by an ordinary user without the necessary radiology expertise; FIG. 6B shows the accuracy of results of the present invention used by users without any training in medical imaging, compared to those of junior/senior doctors using MedSAM;

FIGS. 7A to 7C illustrate the different strategies and mechanisms adopted by the model of the present invention; FIG. 7A illustrates the overall pipeline of the Triple Modality Fusion Transformer; FIG. 7B provides a schematic illustration of the detailed model structure of the three encoders of the model of the present invention; FIG. 7C provides a schematic illustration of the Cross-modality attention mechanism, used to fuse the features of the three modalities;

FIG. 8 provides examples of descriptions generated by the Color Region Description (CRD) strategy across nine modalities, producing information regarding shape and relative location;

FIG. 9 shows the ablation study results, evaluated using held-out set and external set respectively; and

FIG. 10 provides visual comparison samples from the held-out evaluation set.

### DETAILED DESCRIPTION

In accordance with the embodiments of the present invention, provided is a comprehensive, full-stack intelligent segmentation model that facilitates disease classification and localization in addition to medical image segmentation. Notably, users of the intelligent segmentation model are not required to possess medical imaging expertise or training. Through providing human language prompts, the model automatically generates information regarding diseases, their locations, and the corresponding segmentation regions.

To establish robust correlations between images and language inputs, an automatic conversion strategy is designed to convert image-mask pairs to image-mask-description triplets with off-the-shelf VLFMs. The description contains the shape of each region of interest (ROI) and the relative location and size information among different ROIs. Moreover, this strategy generates a unique description for each image, which significantly increases diversity. As such, the model pre-trained with these image-mask-description triplets are capable of producing segmentation results from human language-only prompts, through the tokenization of the human language prompts into tokenized instructions, from which the intelligent segmentation model is triggered to produce segmentation masks corresponding to the segmentation categories as instructed.

Particularly, an embodiment of the present invention can be implemented by an automated medical image segmentation device comprising a human language prompt input unit, an image display unit, and a medical image segmentation processing unit configured to execute the intelligent segmentation model.

With the intelligent segmentation model pre-trained with the methodology as explained in the below section, the automated medical image segmentation device achieves a more than 99% reduction of processing time as compared to current medical image segmentation devices, thereby significantly increasing computational efficiency.

As also described in greater details below, the automated medical image segmentation device is operable by non-radiology specialists to initiate automated medical image segmentation and analysis with accuracy comparable to current medical image segmentation models guided by specialist input as visual cues. The automated medical image segmentation device in accordance with the embodiments of the present invention therefore possesses immense potential in terms of scalability and wider application scenarios.

As used herein, the terms: “Dice similarity coefficient” (abbr. “DSC”), “Dice score” and “Dice coefficient” are used interchangeably and refer to a statistical metric used to measure overlap between two sets, specifically the predicted segmentation mask and the ground-truth segmentation mask. DSC is mathematically expressed as:

$$Dice ( A , B ) = \frac{2 \vert A ⋂ B \vert}{\vert A \vert + \vert B \vert}$$

where A denotes the set of pixels or voxels in the predicted segmentation mask, and B denotes the set of pixels in the ground-truth segmentation mask. DSC falls within a range of 0-1, where DSC=1 means perfect overlap and DSC=0 means no overlap.

As used herein, the term: “Box Intersection over Union” (abbr. Box IoU) refers to a metric used in object detection. For a predicted bounding box A and a ground-truth bounding box B:

$$IoU ( A , B ) = \frac{area ( A ⋂ B )}{area ( A ⋃ B )}$$

where the intersection area is the overlapping region; and the union area is the sum of areas of boxes A and B subtract the intersection area. The range of IoU also falls within 0-1, with 1 indicating perfect overlap and 0 indicating no overlap.

The Examples section below describes the detailed methodology adopted in constructing the model of the present invention, and its performance results in comparison with other medical image segmentation models available.

### Examples

### Methodology:

### 1. Dataset Curation

### Color Region Description Annotating Strategy

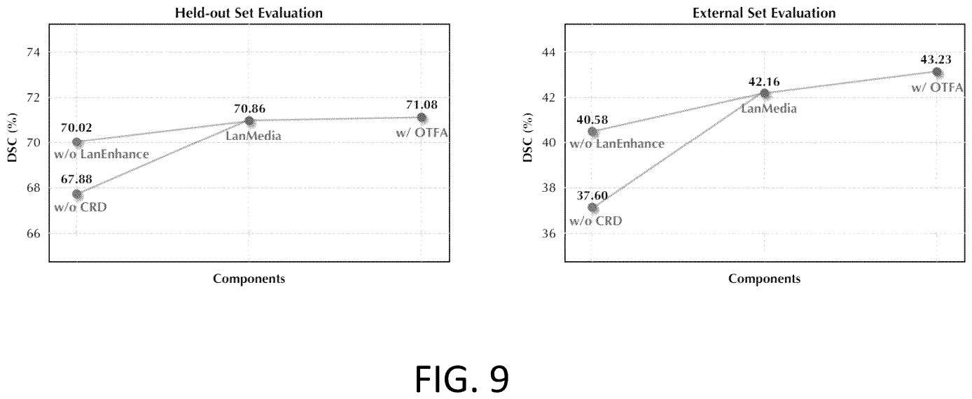

A large number of medical image segmentation datasets exist with image mask pairs. However, datasets for language-driven segmentation tasks are not much. The most straightforward way to build this kind of dataset is using the class names to construct the image-mask-label triplets, like Biomedparse did. However, this straightforward strategy does not establish a robust relationship among the image, mask, and category names, leading to inferior results, especially on external test sets, as shown in FIG. 9. The issue arises from a gap between the semantic information conveyed by the category name and the morphological information represented by the masks. Category names often fail to provide details about the location and shape of anatomical structures, which are crucial for a comprehensive understanding of their morphology. For example, the pancreas undergoes significant shape and location changes across different CT slices; aligning all these variations to a single term, pancreas, is quite challenging for the foundation model. Thus, the slice-wise description is wanted to better guide the model.

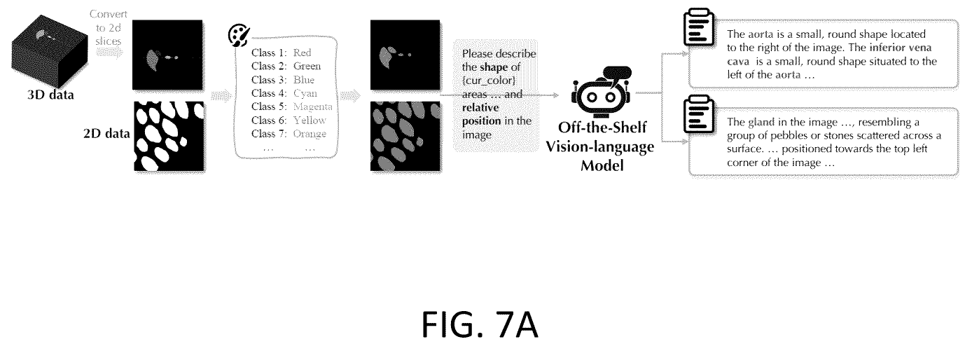

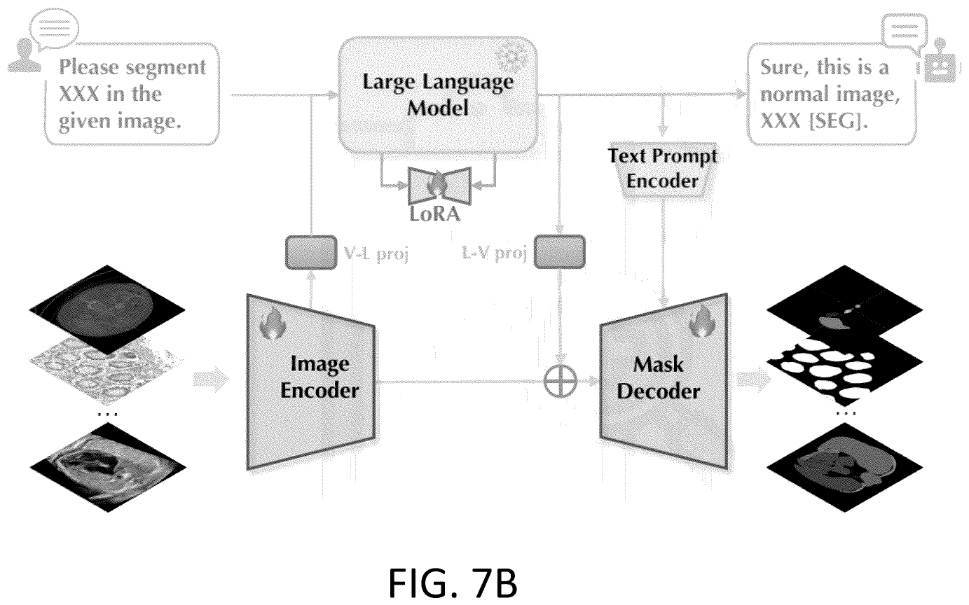

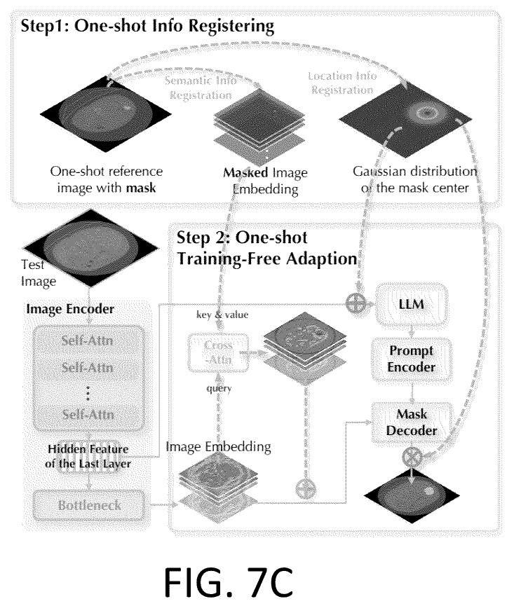

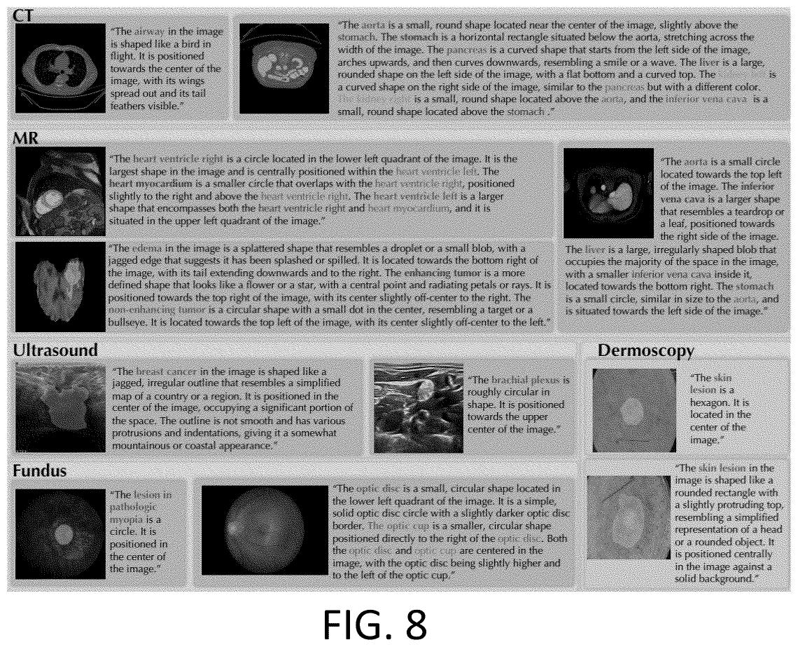

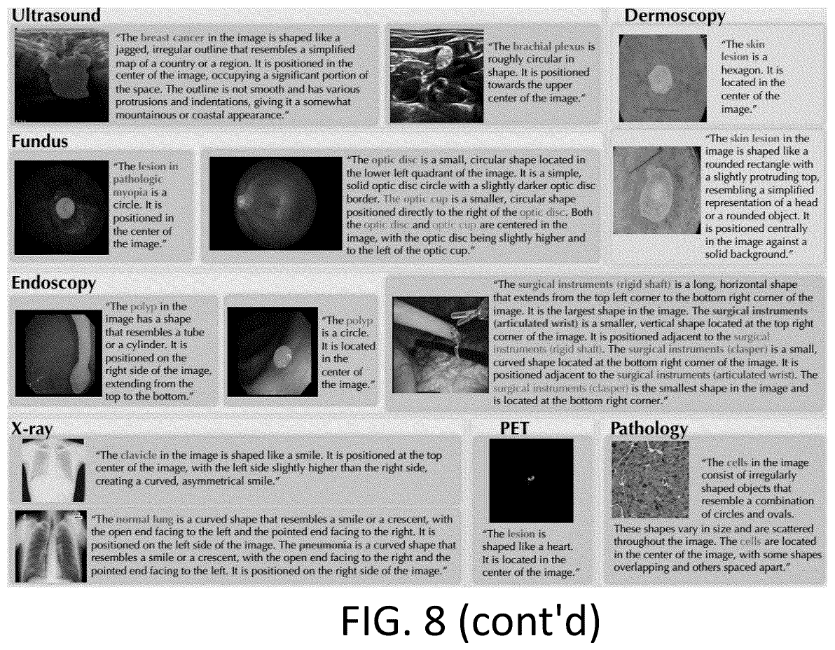

For each image and mask pair, the InternVL-1.5 is leveraged to generate their corresponding text descriptions. Generally, the off-the-shelf large vision-language models (VLMs) such as GPT4, InternVL, QWenVL cannot understand the medical images, i.e., the generated text descriptions are weird. However, they are powerful enough to handle very simple tasks, such as describing different color patches. As illustrated in FIG. 7A, the CRD strategy involves taking 2D masks as inputs and converting each category into distinct pre-defined colors. The choices of colors are arbitrary; and each of the colors corresponds to a distinct tissue type or pathological feature to be recognized and/or segmented. These colored masks are then input into the VLFMs to generate diverse and satisfactory descriptions of the shapes and relative positions of all the colored regions. Several generated descriptions are showcased in FIG. 8.

### Annotating Public Datasets

Utilizing the automated annotation pipeline, a corpus of 20MSA-Med-20M is annotated, which is inherently diverse, high-resolution, and privacy-compliant. The resulting dataset comprises 410 million regions, each associated with a segmentation mask, and includes 7.5 million unique concepts. Further, the dataset features 84 million referring expressions, 22 million grounded short captions, and 11 million densely grounded captions.

Collecting Multi-Disease Data from Hospitals

Public datasets mainly target organ segmentation; there are few disease segmentation datasets, especially cancer. Thus, as a supplement to the public datasets, a comprehensive disease dataset is collected. The dataset is collected from Sun Yat-sen Memorial Hospital, Sun Yat-sen University, Guangdong, China. The dataset consists of 20 common human diseases, especially cancers, covering all the human body systems. The datasets used in the previous text-driven models lack this disease, making them impractical for clinical use. Thus, an in-house external test set is built to test the potential clinical usage of the present model. This test set contains 20 different cancers or rare diseases, covering all the systems in the human body: central nervous system (brain tumor, cerebral infarction, cerebral hemorrhage), head and neck (acoustic neuroma, nasopharynx cancer, tongue cancer, thyroid cancer), respiratory system (lung cancer), circulatory system (thymic carcinoma), digestive system (stomach cancer, pancreas cancer, gallbladder cancer, liver cancer, colon cancer), urinary and reproductive system (bladder cancer, prostate cancer, kidney cancer, ovarian cancer, cervical cancer), musculoskeletal system (osteosarcoma); each disease contains 20 patients from Sun Yat-sen Memorial Hospital, Sun Yat-sen University. The collected MRI and CT images come from a variety of imaging devices. The MR images are captured using machines from Philips (Ingenia 1.5T, Ingenia 3.0T, Achieva 3.0T, Ambition 1.5T) and Siemens (MAGNETOM Skyra 3.0T, MAGNETOM Vida 3.0T, MAGNETOM Avanto 1.5T). The CT images are obtained from Siemens (SOMATOM Force, SOMATOM Sensation 64), United Imaging (uCT780), and GE (Discovery HD, Revolution EVO).

2. Architecture of the Intelligent Segmentation Model in Accordance with the Embodiments of the Present Invention (LanMedia)

LanMedia comprises four logical components: an LLM, an image encoder, a human language prompt encoder, and a mask decoder. To establish a robust correlation between the image and the text, Vicuna LLM with 7B parameters is used as the LLM (L), which has a balance between performance and efficiency. Instead of employing a CLIP-based image encoder, a SAM-based image encoder (V) is used since it has a larger resolution and has better ability in pixel-level image understanding, which is beneficial to the segmentation tasks. V is instantiated with the pre-trained SAM encoder. The prompt encoder and the mask decoder are designed based on a SAM decoder-like architecture. A vision-to-language (V-L) projection layer (pᵥ₋ₗ) is introduced to project the vision features to language features. Specifically, given an image (xᵢ) and a human language instruction xₗ, the image is first encoded into a feature embedding Eᵥ=V(xᵢ)∈ [symbol] ^{cv} and projected to language space pᵥ₋ₗ(Ev)∈ [symbol] ^{cl}. The LLM then integrates both the projected image features and the human language instructions to generate output yₗ: yₗ=L(pᵥ₋ₗ(Eᵥ), xₗ)). This maps image features to language space, enabling LanMedia to learn the correlation between image and human language instructions. This process can also activate certain units of the projected image embedding (Eᵥ₋ₗ=pᵥ₋ₗ(Eᵥ)), which can further benefit the identification of ROIs in the mask decoder. Thus, it is projected back to the vision model with a language-to-vision (L-V) projection layer (pₗ₋ᵥ): Eₗ₋ᵥ=pₗ₋ᵥ(Eᵥ₋ₗ). Eₗ₋ᵥ is then added with the original feature embedding Eᵥ and fed into the mask decoder. Finally, to activate the language-driven segmentation, LanMedia's vocabulary is augmented with a specialized token, <SEG>. Instructions tokenized from human language-only prompts, such as “The <image> provides an overview of the image. Can you segment the {class name} in this image?” trigger the model to generate responses with corresponding <SEG> tokens, where the <image> token is replaced with 1024 tokens from the SAM image encoder, and the {class name} is the target category name the user wants to segment. The vision-to-language (V-L) projection layer (pᵥ₋ₗ) transforms the last-layer embeddings corresponding to <SEG> tokens (E_{seg}) into the decoder's feature space. Subsequently, M produces binary segmentation masks yᵥ, yᵥM(pᵥ₋ₗ(E_{seg}), Eᵥ+Eₗ₋ᵥ), s. t., {yᵥ}ᵢ∈0,1. Using an end-to-end training approach, LanMedia establishes a robust correlation between image and human language, which provides accurate segmentation responses corresponding to the human language instructions.

### One-Shot Training-Free New Class Adaptation

To enhance performance on unseen classes, a one-shot, training-free adaptation strategy is developed, illustrated in FIG. 7C. This approach operates during inference and consists of two key stages: one-shot information registration and adaptation. In the first stage, the model processes a sample—in this case, image-mask pairs from the unseen class—to register semantic and spatial information. The semantic information is derived by multiplying the image features (Eᵥ∈ [symbol] ^{cv×H/16×W/16}) with a resized binary mask (y∈ [symbol] ^{H/16×W/16}) to obtain the masked image embedding Eᵥ⁻, isolating the features relevant to the target area. For location information, a 2D Gaussian distribution is initialized centered at the centroid of the foreground mask region. This method leverages the anatomical consistency of human body structures across different patients, allowing for more accurate localization. Both the semantic and location information are then stored for use in the subsequent stage. In the second stage, a none-parameter cross-attention mechanism is introduced to adapt the semantic information. The image embedding Eᵥ ∈ [symbol] ^{N×Cv} serves as the query while the masked image embedding

$${Ê}_{v}^{∈} {ℝ}^{N \times C v}$$

functions as both the key and value. This results in the target-region-activated image embedding

$${\tilde{E}}_{v} = [ soft max ( {E}_{v} {Ê}_{v}^{⊤} ) ] {Ê}_{v} ,$$

which is then combined with Eᵥ to provide enhanced information for the mask decoder. Additionally, the location information is integrated with the hidden features from the last layer of the image encoder, allowing the model to establish a weak correlation with the text. This integration aids in refining the adaptation process and improves overall performance.

### 3. Training Protocol and Experimental Setting

During data pre-processing, 3.1 million medical image-mask-text triplets are obtained for model development and validation. For internal validation, the dataset is randomly split into 80%, 10%, and 10% as training, tuning, and validation, respectively. Specifically, for modalities where within-scan continuity exists, such as CT and MRI, and modalities where continuity exists between consecutive frames, the data splitting is performed at the 3D scan, by which any potential data leak is prevented. For the external validation, all datasets are held out and do not appear during model training. These datasets provide a stringent test of the model's generalization ability, as they represent new patients, imaging conditions, and potentially new segmentation tasks that the model has not encountered before. By evaluating the performance of LanMedia on these unseen datasets, a realistic understanding is gained of how LanMedia is likely to perform in real-world clinical settings, where it needs to handle a wide range of variability and unpredictability in the data. The training and validation are independent.

### 4. Implementation Details

The experiments are conducted on 32 NVIDIA® H800 GPUs. The vision-language framework is inspired by GLaMM, utilizing 2-layer MLPs with GELU activation for the V-L and L-V projection layers, similar to LLaVA-v1.5. The vision modules are initialized using SAM with ViT-H weights. The implementation of LanMedia is done in PyTorch, employing Deepspeed zero-2 optimization during training. The model undergoes end-to-end training for 5 iterations, utilizing the Adam optimizer with a polynomial decay policy and an initial learning rate of 1e-2. Specifically, the training incorporates two types of losses: an auto-regressive cross-entropy loss for text generation and a linear combination of per-pixel binary cross-entropy loss and DICE loss for segmentation. During this process, the image encoder, projection layers (both V-L and L-V), prompt encoder, and mask decoder are fully fine-tuned, while the LLM is fine-tuned using LoRA with α=8. The text instruction is formulated in the pre-defined conversation format. For example, “A chat between a curious human and an artificial intelligence assistant. The assistant gives helpful, detailed, and polite answers to the human's questions. USER: Can you segment the {class name} in this {modality} image?ASSISTANT: This is a <p>{modality}</p> image. The image contains <p> label </p>[SEG].” A token [SEG] is added for the segmentation task, which is a 1D token that is further processed by the prompt encoder of SAM.

### 5. Evaluation Metrics

As aforementioned, the reconstruction quality of the method is evaluated from quantitative metrics, visual comparison, and clinical validation. In this section, the definition of the above evaluation metrics and scores is formally introduced. Given a reconstructed bone model \hat{B} and the reference bone model (ground-truth) B, \hat{P} and P are denoted as the points in the surface of \hat{B} and B, respectively. Therefore, average symmetric surface distance (ASSD) and Hausdorff distance (HD) are defined as:

$$d ( x , Y ) = {min}_{y ∈ Y} {‖ x - y ‖}_{2} ,$$

$$ASSD ( \hat{P} , P ) = \frac{1}{2} ( Mean \{ d ( \hat{p} , P ) \vert ∀ \hat{p} ∈ \hat{P} \} + Mean \{ d ( p , \hat{P} ) \vert ∀ p ∈ P \} ) ,$$

$$HD ( \hat{P} , P ) = max \{ {max}_{\hat{p} ∈ \hat{P}} d ( \hat{p} , P ) , {max}_{p ∈ P} d ( p , \hat{P} ) \} .$$

In practice, 16,348 points are uniformly sampled from each bone model as finite point sets to approximate \hat{ }P and P for the above calculation. In addition, the bone models are voxelized into binary volumes (0: bone; 1: others) \hat{ }and V for the Dice similarity coefficient (DSC, %) calculation using the definition of true positive (TP), false positive (FP), and false negative (FN), given by:

$$D S C ( \hat{V} , V ) = \frac{2 T P}{2 TP + FP + FN} .$$

### Results:

### 1. Overview of LanMedia and LanDSD Dataset

LanMedia serves as a full-stack foundational model with only language guidance for comprehensive universal medical image segmentation, encompassing automated disease classification, localization, and segmentation. To achieve this, it is essential to establish a strong correlation among images, masks, and text instructions. During the inference stage, external assistance cannot be obtained to bridge the semantic gap between the target category and regions in the image as interactive models do. LanMedia utilizes a framework based on a model that features both a vision encoder and a decoder-based language model. For the language model, the efficient and powerful Vicuna-7B is used. The vision encoder is represented by SAM-H, employing its prompt encoder and mask decoder to perform prompt-able segmentation tasks.

The next step is to build a large-scale segmentation dataset with language instructions to train this model. However, obtaining diverse large-scale triplets of images, masks, and descriptions in the field of medical imaging remains a significant challenge, as directly inputting medical images into off-the-shelf large-scale vision-language foundation models can result in inaccurate responses. This issue arises because these models are primarily trained on datasets where over 95% of the samples are natural images, making them ill-equipped to understand medical images. To effectively utilize these models, the description of image-mask pairs is proposed to be treated as a Color Region Description (CRD) task, which is then compatible with off-the-shelf foundation models. As illustrated in FIG. 7A, the CRD strategy involves taking 2D masks as inputs and converting each category into distinct pre-defined colors. These colored masks are then input into the models to generate diverse and satisfactory descriptions of the shapes and relative positions of all the colored regions. Finally, based on the SA-Med2D-20M dataset, the largest Language-Driven Segmentation Dataset (LanDSD), comprising 20 million image-mask-description triplets covering 9 imaging modalities and 177 segmentation tasks, is constructed, effectively bridging the gap between diverse masks and limited types of text and builds robust correlation among image, mask and language. Considering the inaccessibility of the masks in the inference stage, only the category name is used as the description prompt for prediction.

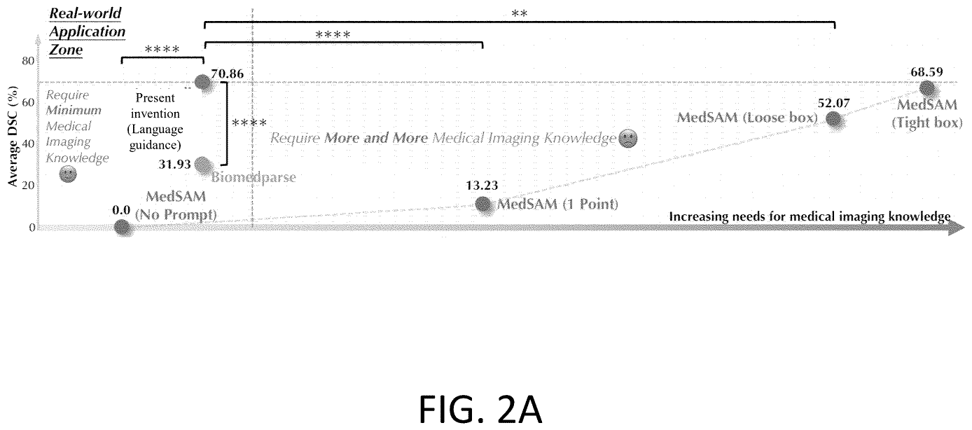

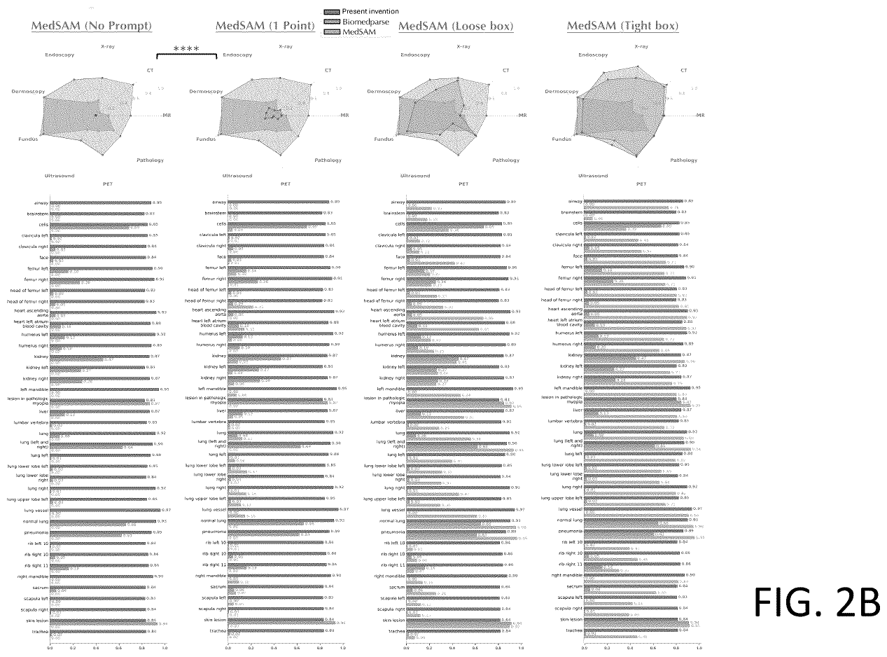

20% of the LanDSD data is held out to comprehensively evaluate the model's performance. As the interactive models are out-of-the-box universal segmentation methods trained on large-scale data, they are directly used on this data without fine-tuning. However, due to the inconsistent training data, some of the held-out data is also involved in training MedSAM, which means the held-out test set used might be leaked in training MedSAM. Additionally, an external validation set consisting of completely unseen images from different distributions is created to assess generalizability. More importantly, a multinational in-house multi-cancer validation set sourced from hospitals in China and Egypt is compiled to evaluate performance on practical clinical tasks. To ensure a fair comparison with previous interactive models, existing segmentation foundation models are categorized based on the medical imaging knowledge needed for prompting (see FIG. 2A) since previous state-of-the-art methods, such as MedSAM and SAM, generally require bounding boxes generated from the mask of the testing set.

### 2. Segmentation Performance Across Modalities

The model in accordance with the embodiments of the present invention, LanMedia, is designed to fill the gap of existing segmentation foundation models in real-world applications. The user breadth and the time costs of obtaining the segmentation are crucial factors that measure applicability. To achieve a large user breadth, the model should be user-friendly has a minimum specific knowledge threshold.

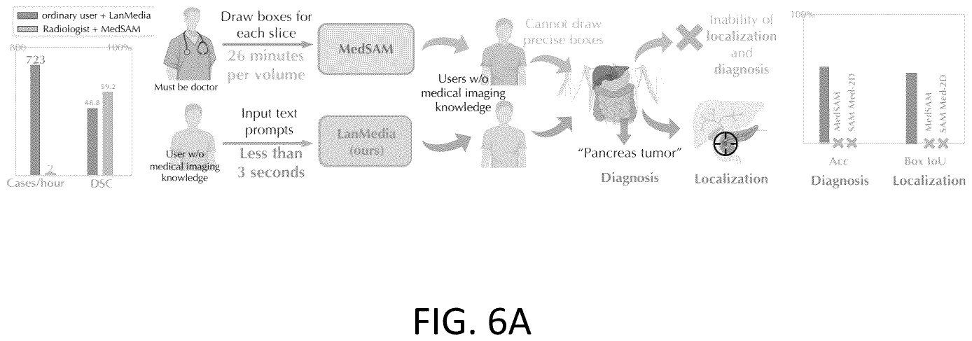

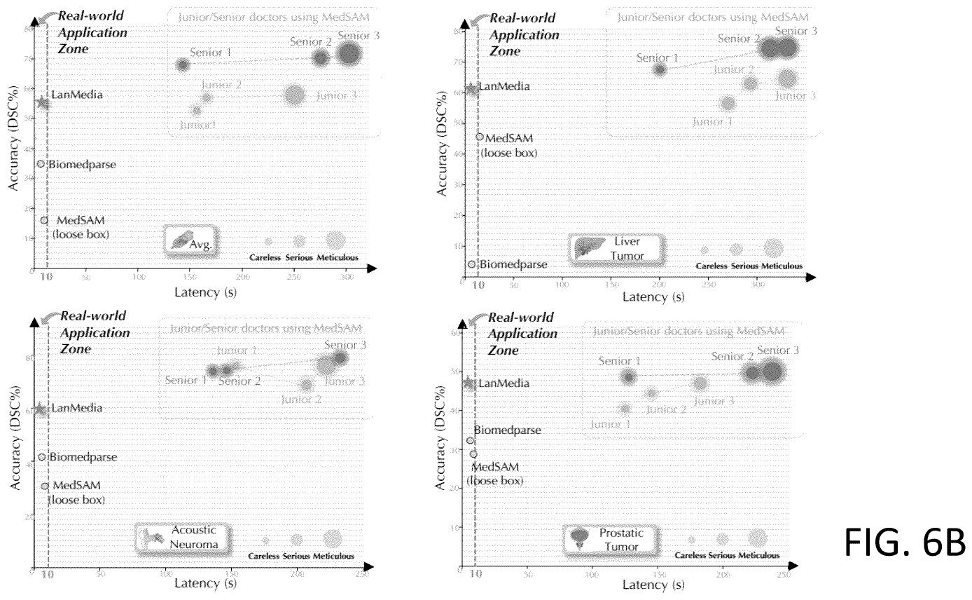

In the following description, user breadth is compared with the state-of-the-art segmentation foundation model, MedSAM, on 835,081 held-out samples (see FIGS. 2A and 2B). The time costs are further evaluated, as shown in FIG. 6A. MedSAM, as a variant of SAM, offers several types of prompt modes for user input: (1) no prompt (no need to provide any guidance), (2) point prompt (use point(s) to indicate target in each image), (3) box prompt, which involves creating the minimum rectangle box encompassing the ground truth, which is referred to as the tight box prompt. In contrast, the loose box prompt refers to a rough bounding box that typically shifts more than 15% from the tight bounding box. As shown in FIG. 2A, these prompt modes demand increasingly higher medical imaging knowledge, and only the no-prompt mode of SAM and human language prompt of LanMedia are practical and applicable in the real world. LanMedia significantly outperforms MedSAM with no prompt, 1 point prompt, and loose box prompt modes by 70.86%, 57.63%, and 18.79% in terms of average Dice score over all the samples in the held-out set across nine modalities (see FIG. 2B). Notably, LanMedia also surpasses MedSAM with tight box prompts by 2.27% on average, indicating that the language guidance is more stable than the box prompts when solving seen tasks. These results indicate that with barely any medical imaging knowledge, LanMedia can serve as a practical and applicable foundation model for various tasks across various modalities.

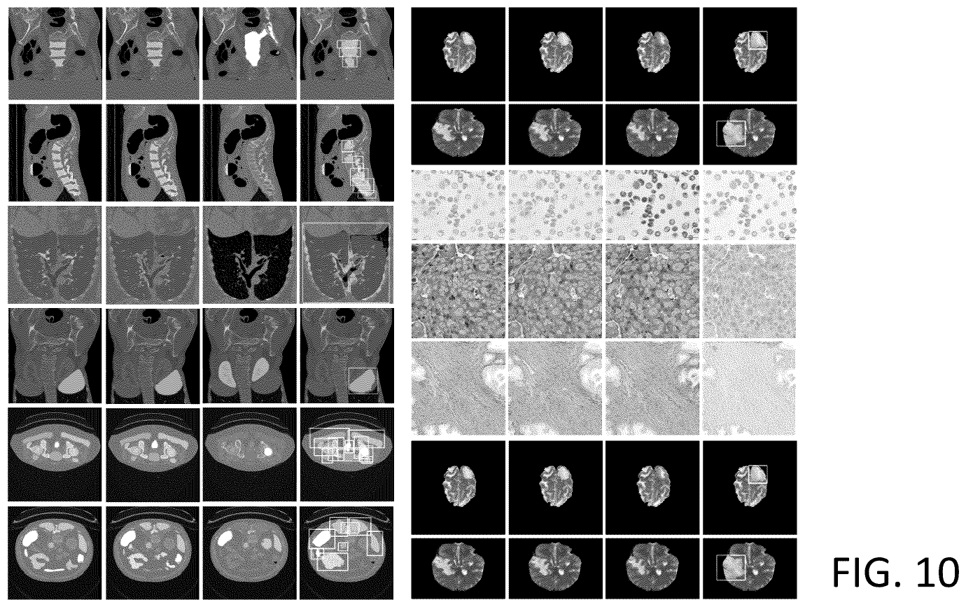

A qualitative comparison between LanMedia, MedSAM (both loose and tight box modes), and the ground truth across various imaging modalities is presented (see FIG. 10). It is observed that MedSAM closely adheres to the box prompts, and boundary identification heavily relies on the box. MedSAM performs well when the target objects are regular shapes, meaning they have a larger foreground area compared to the background within the bounding box. However, it struggles to accurately identify the boundaries of objects with irregular shapes, such as the pancreas. In contrast, LanMedia demonstrates better boundary identification ability and performs well on irregular objects. This also verifies that establishing the correlation between language and image is more stable than forcing the model to follow the box prompts strictly.

### 3. Generalizability of LanMedia on External Datasets

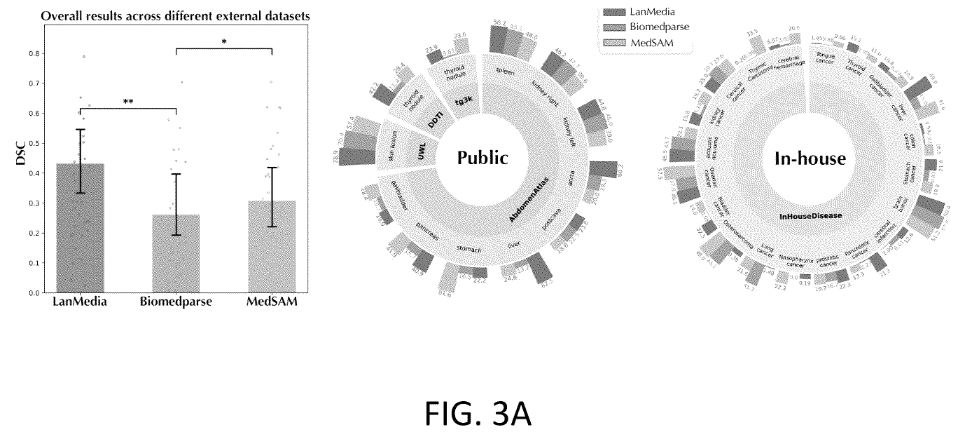

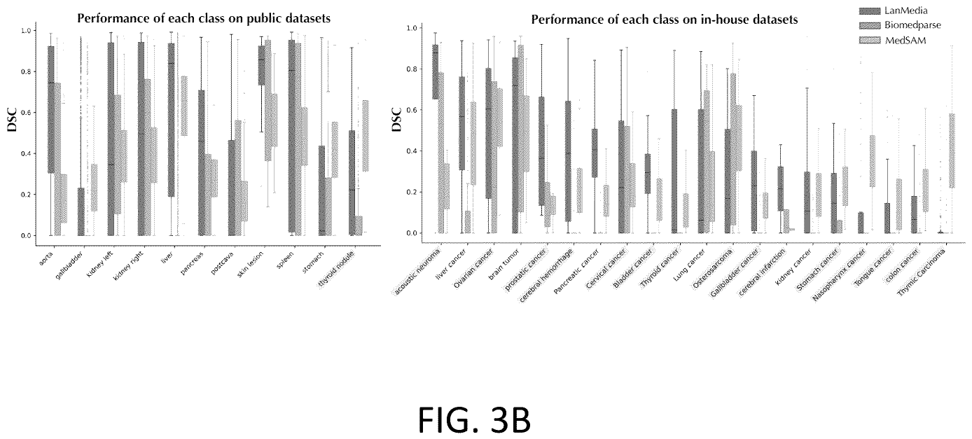

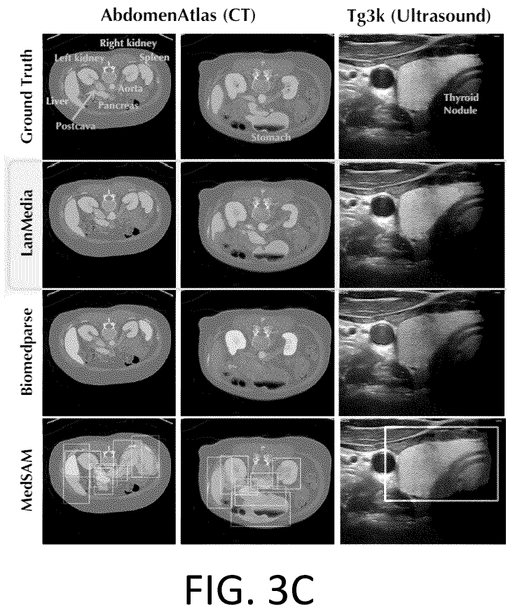

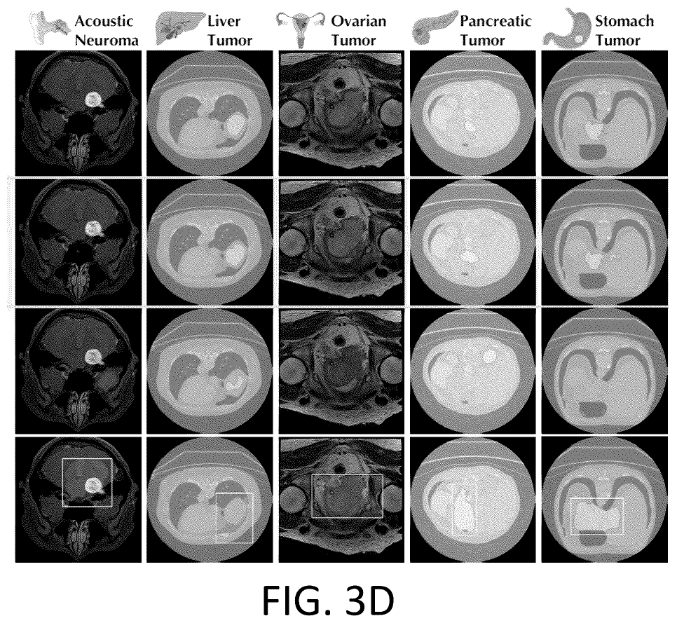

To evaluate the generalizability of LanMedia, the model is further tested on external datasets that are not involved in the training process. LanMedia is compared with the existing state-of-the-art text-driven segmentation model, Biomedparse and MedSAM. To make a relatively fair comparison, the loose box prompt mode of MedSAM (with random 0-15% box shifts) is used, even though the boxes are still generated from the testing ground truth. Overall, LanMedia significantly outperforms Biomedparse (paired t-test P value <10⁻²), and gains 5.24% improvement over MedSAM, as shown in FIG. 3A.

The external datasets consist of public datasets and in-house datasets. The public datasets comprise CT multi-organ, ultrasound thyroid nodule, and dermoscopy skin lesion segmentation tasks. The fundamental principle of imaging diagnosis is familiar with the normal enables the identification of the abnormal. Radiologists must thoroughly understand normal cases at the start of their career training. When they encounter abnormalities, they can quickly compare these findings with the normal examples stored in their memory and recognize the differences. Therefore, the ability to accurately segment normal organs is crucial. This method demonstrates an average improvement of 4.67% on the AbdomenAtlas dataset over Biomedparse and MedSAM. The enhancements are particularly notable in the segmentations of the liver (49.3% and 37.9%) and aorta (31.9% and 40.2%), indicating a better understanding of normal organs. Additionally, this method achieves improvements of 8.5% and 13.8% over MedSAM on uwaterloo (dermoscopy) and DDTI (ultrasound), showcasing its versatility.

Moreover, tumor segmentation is one of the most useful procedures in chemotherapy and radiotherapy since precise tumor shape and size evaluation is needed to determine the cancer states. However, existing segmentation datasets are insufficient to cover common cancers, which is not helpful in clinical application scenarios. A multinational multi-cancer test dataset is developed using in-house data from hospitals in China and Egypt. This test dataset includes 20 segmentation targets from CT and MR modalities. For each type of cancer, 20 well-annotated 3D volumes are available, resulting in 23,253 2D slices. As shown in FIG. 3B, most of the cancers are unseen classes during training, which is very challenging for the text-driven segmentation methods since the correlation between these cancers and the images is not established. As a result, most of the Dice scores of the previous state-of-the-art method, Biomedparse, are below 30%. In contrast, interactive methods are class-agnostic, and with the information from ground truths, they show better generalizability. However, LanMedia surprisingly demonstrates significant improvements over Biomedparse and comparable results with MedSAM, especially on the tasks of acoustic neuroma, ovarian cancer, and prostatic cancer. This can be attributed to the superior performance of normal organs, which indicates LanMedia learns the general patterns of normality. As a result, when faced with abnormalities, LanMedia can recognize and segment them, even in previously unseen cases. For instance, the model has been trained on numerous normal brain images. Consequently, it can identify which regions are abnormal, even without having the concept of Acoustic Neuroma.

In the visual comparison results as shown in FIGS. 3C and 3D, it is found that the main principle of interactive methods is to adhere to the prompt, whereas LanMedia is designed to comprehend the images.

### 4. Capability of LanMedia to Assist in Multiple Clinical Tasks

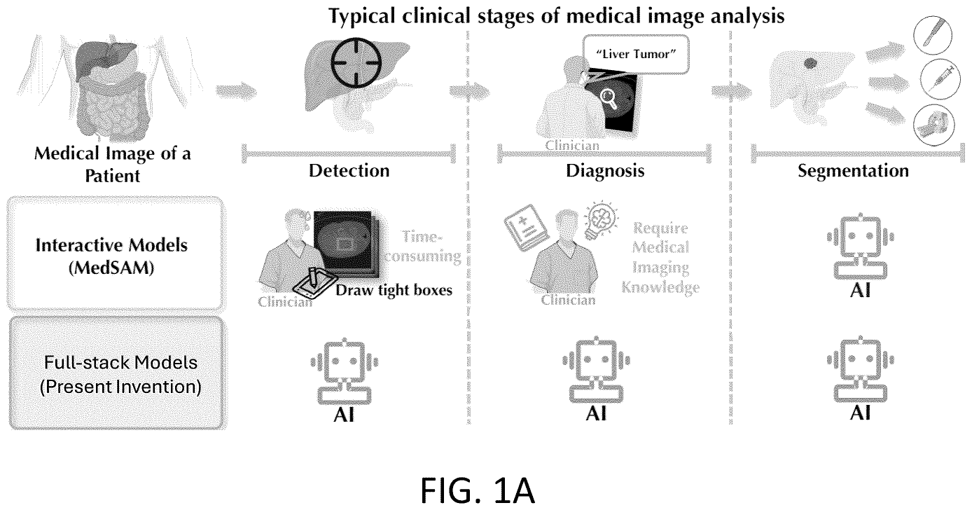

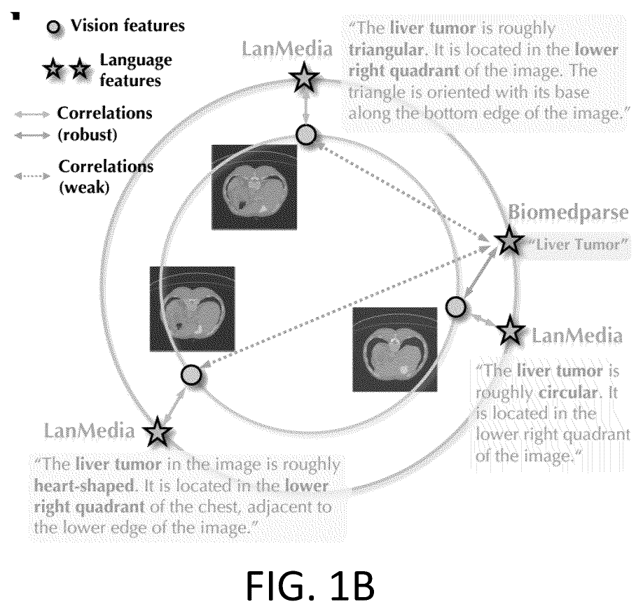

Segmentation plays a crucial role in various fields, including morphological examinations, 3D printing, radiotherapy, and numerous clinical applications. Traditionally, obtaining a segmentation mask using interactive models like MedSAM involves two significant steps: first, identifying the targets within the image, which necessitates expert-level medical imaging knowledge; second, drawing bounding boxes around these targets, a process that is often time-consuming and labor-intensive, as illustrated in FIG. 1A. This workflow is not only impractical but also poses a bottleneck in real-world clinical settings where time and accuracy are paramount. In contrast, LanMedia leverages established language-image correlations to streamline this process. By reducing or even eliminating the need for expert-level user inputs, LanMedia can autonomously provide both diagnosis (recognition) and detection of targets within medical images. This advancement significantly enhances workflow efficiency, allowing healthcare professionals to devote more time to patient care rather than labor-intensive image analysis.

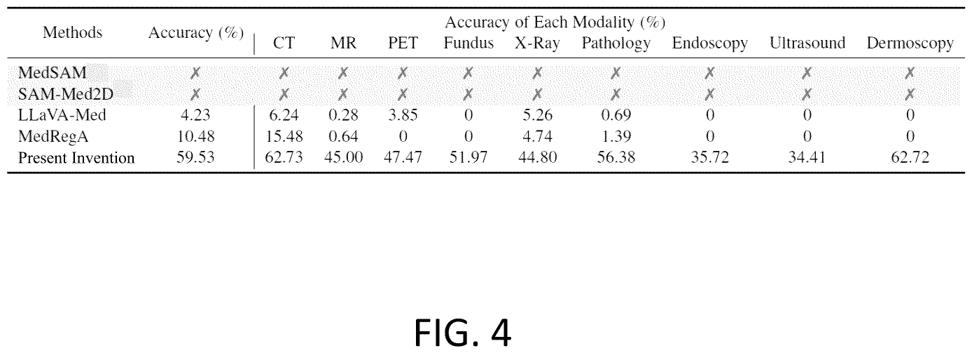

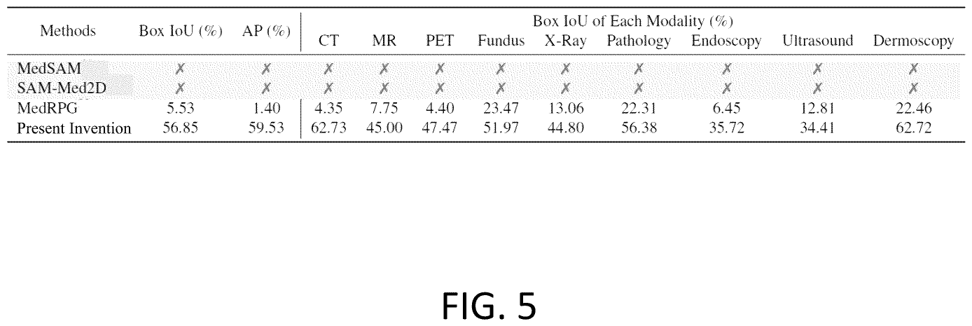

As tabulated in FIGS. 4 and 5, existing segmentation models often fall short in performing both diagnosis and detection tasks, as evidenced by the “X” entries. Although some medical vision-language models incorporate localization capabilities, they are typically tailored for specific modalities and frequently lack robust segmentation functionalities. This limitation restricts their practical application in diverse clinical environments. In contrast, LanMedia not only provides advanced segmentation capabilities but also facilitates effective localization. Notably, LanMedia has achieved a Box IoU improvement of over 50% compared to MedRPG, underscoring its superior performance. By integrating comprehensive segmentation and localization functions, LanMedia stands to redefine the standards of medical imaging analysis, making it more accessible and practical for a wider range of clinical applications. This breakthrough not only promises to reduce the workload on medical professionals but also aims to enhance diagnostic accuracy, ultimately leading to better clinical outcomes.

5. Comparable Performance with Radiologists without Requiring Medical Imaging Knowledge and Enhanced Applicability in Clinical Scenarios

LanMedia achieves comparable performance with radiologists but requires no medical imaging knowledge and is far more applicable in clinical scenarios. To clearly understand the performance of LanMedia against existing segmentation foundation models (MedSAM and Biomedparse) in a clinical setting, the performances of LanMedia and six general radiologists with different levels of expertise using MedSAM are compared. The six general radiologists are divided into two groups, a junior group consists of 3 radiologists with 5-10 years of experience in CT and MR imaging diagnosis, and a senior group consists of 3 radiologists with 10-20 years of experience in CT and MR imaging diagnosis. In this study, 25 patients are randomly selected from the prospective validation cohort for performance comparison, including 5 patients with liver cancer, 10 patients with acoustic neuroma, and 10 patients with prostatic cancer, comprising 873 slices requiring segmentation in total. Among them, the segmentation targets of liver tumor and prostatic tumor are seen during training process, but data distributions are different, while the acoustic neuroma is neither part of the training nor the held-out validation sets.

In real-world applications, two key factors are crucial: accuracy and latency. Therefore, this study compares performance across these two dimensions. To thoroughly evaluate the applicability and clinical value of LanMedia, performance comparisons between ordinary users utilizing LanMedia and radiologists using MedSAM are conducted. Specifically, the radiologists are instructed to annotate tight boxes around the lesions as quickly as possible. These annotated boxes are used as prompts for MedSAM to generate segmentation masks, and the time taken for annotating is recorded.

As seen in FIGS. 6A and 6B, this method achieves comparable results with junior (liver tumor, 60.0% vs. 61.0%) and even senior doctors (pancreatic tumor 25.0% vs. 23.0%) with MedSAM. For the unseen classes, the performance gap is a little bit large. However, diagnosis and localization functions can be provided for any user without medical image knowledge, which is more practical. Regarding latency, the speed includes not only GPU processing time but also the time required for box-prompt annotation. In practical application scenarios, radiologists must first extract bounding boxes when segmentation results are sought using interactive segmentation foundation models. This preliminary step can be exceedingly time-consuming, particularly with 3D data where a meticulous examination slide by slide is necessary. As can be seen in FIG. 6B, there is a huge gap between LanMedia and radiologist using MedSAM. It is important to note that the knowledge requirements in medical imaging vary significantly. For example, while LanMedia achieves a performance of 62.1% in liver tumor segmentation, Junior 2 with MedSAM scores 63.7%. However, LanMedia requires no specialized expertise, whereas MedSAM necessitates over five years of training in medical imaging for users.

The functional units, including the medical image segmentation processing units, of the devices and the methods in accordance to the embodiments disclosed herein may be implemented using specifically configured, computing devices, computer processors, or electronic circuitries including, but not limited to, application specific integrated circuits (ASIC), graphical processing units (GPU), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure. Other function units, including the human language prompt input units and image display units, of the devices and the methods in accordance to the embodiments disclosed herein may also be further implemented using readily available electronic devices and technologies including but not limited to electromechanical user interfaces such as keyboards, electronic touch display screens, and audio transducers.

All or portions of the methods in accordance to the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. The term “substantially coplanar” can refer to two surfaces within micrometers of lying along a same plane, such as within 40 μm, within 30 μm, within 20 μm, within 10 μm, or within 1 μm of lying along the same plane.

As used herein, the singular terms “a,” “an,” and “the” may include plural referents unless the context clearly dictates otherwise. In the description of some embodiments, a component provided “on” or “over” another component can encompass cases where the former component is directly on (e.g., in physical contact with) the latter component, as well as cases where one or more intervening components are located between the former component and the latter component.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit, and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An automated medical image segmentation device configured for segmentation, classification and localization of regions of interest of a target medical image of one of multiple medical image types according to human language instructions, comprising:
a human language prompt input unit for receiving human language instructions in the form of human language-only prompts;
an image display unit for displaying medical images with segmentation results; and
a medical image segmentation processing unit configured to execute an intelligent segmentation model pre-trained with image-mask-description triplets to generate a medical image with segmentation results from the target medical image according to the human language instructions received.

2. The automated medical image segmentation device of claim 1, wherein the intelligent segmentation model comprises:
an image encoder for encoding the target medical image into image features;
a human language prompt encoder for tokenizing the human language instructions into tokenized instructions;
a vision-to-language projection module for projecting the image features to a language space;
a large language model for integrating the projected image features and the tokenized instructions;
a language-to-vision projection module for projecting output generated by the large language model to a vision space; and
a mask decoder for producing binary segmentation masks to generate a medical image with segmentation results.

3. The automated medical image segmentation device of claim 2, wherein the production of the binary segmentation masks by the mask decoder comprises:
inputting the tokenized instructions;
generating responses with specialized tokens corresponding to specific tokens in the tokenized instructions regarding image segmentation categories;
transforming last-layer embeddings into a feature space of the mask decoder corresponding to the specialized tokens by the vision-to-language projection module; and
generating the binary segmentation masks by the mask decoder based on the feature space.

4. The automated medical image segmentation device of claim 1, wherein the intelligent segmentation model is pre-trained with datasets containing image-mask-description triplets, wherein the datasets are constructed by a Color Region Description (CRD) strategy comprising:
receiving 3D medical images;
converting the 3D medical images into 2D slices;
generating 2D masks from the 2D slices;
inputting the 2D masks into a vision-language foundation model;
converting image features contained in the 2D masks into pre-defined colored masks;
inputting the pre-defined colored masks into the vision-language foundation model to generate descriptions; and
combining each of the 2D masks with the corresponding pre-defined colored masks and the descriptions generated to form image-mask-description triplets.

5. The automated medical image segmentation device of claim 1, wherein the medical image types comprise computer tomography (CT) images, magnetic resonance images (MRI), positron emission tomography (PET) scan images, fundus photography images, X-ray images, pathology microscopy images, endoscopy images, ultrasound images and dermoscopy images.

6. The automated medical image segmentation device of claim 1, wherein the intelligent segmentation model has an average improvement of 4% in Dice similarity coefficient (DSC) over conventional medical image segmentation models.

7. The automated medical image segmentation device of claim 1, wherein the intelligent segmentation model has a classification accuracy of at least 30% higher than conventional multi-model large foundation models.

8. The automated medical image segmentation device of claim 1, wherein the intelligent segmentation model has a Box Intersection over Union (IoU) of at least 20% higher than conventional multi-model large foundation models.

9. A method of automated segmentation, classification and localization of regions of interest of a target medical image of one of multiple medical image types according to human language-only prompts using an automated medical image segmentation device, comprising:
receiving the target medical image to be processed by the device;
receiving human language instructions in the form of human language-only prompts by a human language prompt input unit of the device;
tokenizing the human language instructions into tokenized instructions by a human language prompt encoder executed by a medical image segmentation processing unit of the device;
encoding the target medical image into image features by an image encoder executed by a medical image segmentation processing unit of the device;
projecting the image features to a language space by a vision-to-language projection module executed by the medical image segmentation processing unit;
integrating the projected image features and the tokenized instructions by a large language model executed by the medical image segmentation processing unit;
projecting output generated by the large language model to a vision space by a language-to-vision projection module executed by the medical image segmentation processing unit;
feeding the output in the vision space to a mask decoder executed by the medical image segmentation processing unit;
producing binary segmentation masks by the mask decoder to generate a medical image with segmentation results; and
displaying the medical image with segmentation results by an image display unit of the device.

10. The method of claim 9, wherein the production of the binary segmentation masks by the mask decoder comprises:
inputting the tokenized instructions;
generating responses with specialized tokens corresponding to specific tokens in the tokenized instructions regarding image segmentation categories;
transforming last-layer embeddings into a feature space of the mask decoder corresponding to the specialized tokens by the vision-to-language projection module; and
generating the binary segmentation masks by the mask decoder based on the feature space.

11. The method of claim 9, wherein processing rate of the method is no less than 700 medical images per hour.

12. The method of claim 9, wherein the medical image types comprise computer tomography (CT) images, magnetic resonance images (MRI), positron emission tomography (PET) scan images, fundus photography images, X-ray images, pathology microscopy images, endoscopy images, ultrasound images, and dermoscopy images.

13. The method of claim 9, wherein the method has an average improvement of 4% in Dice similarity coefficient (DSC) over conventional medical image segmentation models.

14. The method of claim 9, wherein the device has a classification accuracy of at least 30% higher than conventional multi-model large foundation models.

15. The method of claim 9, wherein the method has a Box Intersection over Union (IoU) of at least 20% higher than conventional multi-model large foundation models.
